(19) United States
(12) Patent Application Publication
(10) Pub. No.: US 2013/0163007 A1
(43) Pub. Date: Jun. 27, 2013

(54) LENS ARRAY AND LENS EDGE DETECTION METHOD THEREOF

(71) Applicants: Masahiro Tanazawa, Kawaguchi-shi (JP); Shinya Kanke, Kawaguchi-shi (JP)

(72) Inventors: Masahiro Tanazawa, Kawaguchi-shi (JP); Shinya Kanke, Kawaguchi-shi (JP)

(73) Assignee: ENPLAS CORPORATION, Kawaguchi-shi, Saitama (JP)

(21) Appl. No.: 13/818,963

(22) PCT Filed: Sep. 13, 2011
(86) PCT No.: PCT/JP2011/070848

§ 371 Date: Feb. 25, 2013

(30) Foreign Application Priority Data
Sep. 14, 2010 (JP) 2010-205063

(51) Int. Cl. G01B 11/14

(52) U.S. Cl. CPC G01B 11/14
USPC 356/614

(57) ABSTRACT

To enable detection of images of peripheral end sections of a first lens face 4 and a second lens face 6, when the positions of the first lens face 4 and the second lens face 6 are measured, to be performed simply by detection operations on the first lens face 4 side, the first lens face 4 is formed having a smaller diameter than the second lens face 6 corresponding to the first lens face 4, and the image of the peripheral end section of the second lens face 6 can be detected from the first lens face side by transmission of light from a light-transmissive substrate 2.

### TECHNICAL FIELD

The present invention relates to a lens array and a lens edge detection method for the lens array. In particular, the present invention relates to a lens array and a lens edge detection method for the lens array suitable for detecting a peripheral edge section of a lens face when a position of a lens face is measured.

### BACKGROUND ART

In recent years, in reflection of the need for higher-speed communication and more compact communication devices, there has been an increasing demand for a lens array in which a plurality of lenses are arranged in parallel, as a compactly structured optical component effective for actualizing multichannel optical communication.

In an actual state of use, this type of lens array is configured such that, for example, a photovoltaic device including a plurality of light-emitting elements, such as a vertical cavity surface emitting laser (VCSEL), is attached thereto with the light-emitting elements respectively facing the lens faces on the incident side of the lens array. In addition, a plurality of optical fibers serving as an example of a optical transmission body are attached to the lens array with the end faces of the optical fibers respectively facing the lens faces on the emission side of the lens array. In a state in which the lens array is disposed between the photovoltaic device and the optical fibers in this way, the lens array optically couples the light emitted from each light-emitting element of the photovoltaic device to the end face of each optical fiber by each lens. As a result, multichannel optical communication (transmission) can be performed.

In addition to use in transmission such that described above, the lens array is also used for reception by optically coupling the end faces of the optical fibers to light-receiving elements (such as photodetectors) provided in the photovoltaic device, as well as being used to optically couple the end faces of optical fibers with each another. This type of lens array is most commonly formed by a resin material (such as polyetherimide) being injection-molded using a mold.

Here, FIG. 7 is a cross-sectional view of an example of a lens array 1 that has been conventionally used, such as that described above. FIG. 8 is a planar view of FIG. 7. FIG. 9 is a bottom view of FIG. 7.

As shown in FIG. 7, the lens array 1 has an elongated plate-shaped light-transmissive substrate 2 of which the planar shape is substantially rectangular. A plurality of convex first lens faces 4 are formed on one end surface, or in other words, an upper end surface 3 in the thickness (plate thickness) direction (up/down direction in FIG. 7) of the light-transmissive substrate 2. As shown in FIG. 8, the first lens faces 4 are formed in an array such as to be adjacent to each other along the length direction of the light-transmissive substrate 2. The outer shape of each first lens face 4 is formed into a circle, each having the same diameter. In FIG. 8, the upper end surface 3 is formed into a two-level structure composed of a center area 3a and a peripheral area 3b. The first lens faces 4 are formed in the center area 3a. In a state of use, the first lens faces 4 respectively face, for example, the end faces of a plurality of optical fibers.

On the other hand, as shown in FIG. 7, convex second lens faces 6 are formed on the other end surface, or in other words, a lower end surface 5 in the thickness direction of the light-transmissive substrate 2. The number of second lens faces 6 is the same as the number of first lens faces 4. As shown in FIG. 9, the second lens faces 6 are also formed in an array such as to be adjacent to each other along the length direction of the light-transmissive substrate 2, in a manner similar to the first lens faces 4. In addition, the outer shape of each second lens face 5 is formed into a circle, each having the same diameter. Furthermore, the second lens faces 6 are formed in adherence to a design in which the optical axis of each second lens face 6 matches that of its corresponding first lens face 4 (in other words, the first lens face 4 and the second lens face 6 are coaxial). The second lens faces 6 are also formed having the same diameter as the first lens faces 4. The optical axis direction of the first lens face 4 and the second lens face 6 is equivalent to the up/down direction in FIG. 7. In FIG. 9, the lower end surface 5 is formed into a two-level structure composed of a center area 5a and a peripheral area 5b. The second lens faces 6 are formed in the center area 5a. In a state of use, the second lens faces 6 respectively face, for example, a plurality of light-emitting elements of a photovoltaic device.

Furthermore, as shown in FIG. 7 to FIG. 9, a pair of positioning holes 7 are respectively formed in positions on both outer sides in the array direction of the formation area of the first lens faces 4 and the second lens faces 6 in the light-transmissive substrate 2. The positioning holes 7 are used to position the optical fibers or the photovoltaic device to be attached to the lens array 1. Each positioning hole 7 is formed such as to pass through the light-transmissive substrate 2 in the up/down direction, from the peripheral area 3b of the upper end surface 3 to the peripheral area 5b of the lower end surface 5. The upper end surface 3 maybe formed such that the areas in which the positioning holes 7 are formed are stepped from both the center area 3a and the peripheral area 3b. Similarly, the lower end surface 5 may be formed such that the areas in which the positioning holes 7 are formed are stepped from both the center area 5a and the peripheral area 5b. In a state of use, for example, fiber positioning pins disposed in a multi-core integrated connector housing the end sections of the plurality of optical fibers are fitted into the positioning holes 7 from the first lens face 4 side. In addition, device positioning pins disposed on a semiconductor substrate of the photovoltaic device are fitted into the positioning holes 7 from the second lens face 6 side. However, depending on the positioning structures on the optical fiber side and the photovoltaic device side, a projecting section, a hole section (bottomed hole) , or a structure combining the two maybe formed in place of each positioning hole 7.

The lens array 1 such as that described above has been proposed in the past, such as in Patent Literature 1.

To actualize favorable optical coupling efficiency, in the lens array 1 such as this, importance has been placed on the position accuracy of each first lens face 4 and second lens face 6, particularly the relative position accuracy (in other words, coaxial accuracy) between the first lens face 4 and the second lens face 6 that correspond with each other.

Therefore, when the position of each first lens face 4 and second lens face 6 is measured to determine the position accuracy of the first lens face 4 and the second lens face 6, extremely high measurement accuracy in the micron order or smaller is required.

Here, FIG. 10A and FIG. 10B show an overview of position measurement of the first lens face 4 and the second lens face 6 of the lens array 1 that has been conventionally used, such as described above.

As shown in FIG. 10A and FIG. 10B, in the position measurement of the first lens face 4 and the second lens face 6, a measuring device 8 has been conventionally used that detects (captures) an enlarged image of the first lens face 4 and the second lens face 6 based on the principles of a microscope, and performs position measurement based on the detection result. A non-contact, three-dimensional measuring device (manufactured by Mitaka Kohki Co., Ltd.) and other microscopes can be given as examples of the measuring device 8.

When the position measurement is performed using the measuring device 8 described above, for example, first, the lens array 1 is set on an XY stage 10 of the measuring device 8 such that the first lens faces 4 face an objective lens 11 of the measuring device 8, as shown in FIG. 10A. The XY stage 10 can be moved in an X-direction (left/right direction in FIG. 10A and FIG. 10B) and a Y-direction (direction perpendicular to the paper surface on which FIG. 10A and FIG. 10B are printed) by an actuator (not shown). The objective lens 11 can be moved in a Z-direction (up/down direction in FIG. 10A and FIG. 10B) by an auto-focus mechanism (not shown). The Z-direction is equivalent to the optical axis direction of the lens array 1 when the lens array 1 is set on the XY stage 10.

Next, the XY stage 10 and the objective lens 11 are moved accordingly. In addition, laser light emitted from a laser light source 12 of the measuring device 8 is converged by the objective lens 11 and irradiated onto the lens array 1. While the reflected light of the laser light is imaged on a charge-coupled device (CCD) camera 14 through the objective lens 11, an image of an end section on the first lens face 4 side of the inner peripheral surface of one positioning hole 7 (referred to, hereinafter, as a first inner peripheral surface end section) is detected. An optical system, such as a beam splitter 15 and a lens 16, is disposed as required on the optical path between the objective lens 11 and the CCD camera 14. In addition, the detected image from the CCD camera 14 can be checked on a screen of a monitor television (TV) 18.

Here, the detection of the image of the first inner peripheral surface end section of the positioning hole 7 is performed as a series of detection operations in which an operation in which the objective lens 11 is focused on a single point on the first inner peripheral surface end section of the positioning hole 7 is repeatedly performed for a plurality of differing points on the first inner peripheral surface end section, thereby detecting an image of each point. During this process, every time an image of a point is detected, the coordinates of the point are acquired. However, regarding the coordinates at this time, the point of origin is set to a position on the XY stage 10 based on the measuring device 8.

When the above-described detection of the image of the first inner peripheral surface end section of the positioning hole 7 is completed, or in other words, when the images of all of the plurality of points described above have been detected, the barycentric coordinates of the coordinates of the points that are currently acquired are calculated. As a result, the coordinates of a center point of the first inner peripheral surface end section of the positioning hole 7 are determined.

Furthermore, the above-described calculation for the coordinates of the center point of the first inner peripheral surface end section is performed on the other positioning hole 7 as well.

Next, a line segment L connecting the center points of the first inner peripheral surface end sections of the two positioning holes 7 calculated as described above is determined (see FIG. 11). Based on the determined line segment L, the coordinates of a single point on the lens array 1 to serve as a position reference point during measurement of the position of the first lens face 4 is calculated. The single point on the lens array 1 may be, for example, a point P at which a perpendicular bisector (dashed line in FIG. 11) of the line segment L intersects with a front end section of the upper end surface 3, as shown in FIG. 11.

Next, coordinate transformation is performed with the coordinates of the point P on the lens array 1, calculated as described above, as the point of origin (0,0). As a result, the position reference point for the measurement of the position of the first lens face 4 is set.

Next, in a manner similar to the detection of the image of the first inner peripheral surface end section of the positioning hole 7, detection of an image of a peripheral end section (or in other words, the contour or the outline) of the first lens face 4 is performed as detection operations of the images of a plurality of points on the peripheral end section of the first lens face 4. During this process, every time an image of a point on the peripheral end section of the first lens face 4 is detected, the coordinates of the point with reference to the reference point (or in other words, the point of origin (0,0)) are acquired.

Then, when the above-described detection of the image of the peripheral end section of the first lens face 4 is completed, the barycentric coordinates of the coordinates of the points on the peripheral end section of the first lens face 4 that are currently acquired are calculated. As a result, the coordinates of a center point of the first lens face 4 with reference to the reference point are determined.

Furthermore, the above-described calculation for the coordinates of the center point of the first lens face 4 is performed on all first lens faces 4. The position measurement of the first lens face 4 is thereby completed.

Next, after the above-described position measurement of the first lens face 4 is completed, the lens array 1 is then reversed (turned over) from the state shown in FIG. 10A and is set on the XY stage 10 such that the second lens faces 6 face the objective lens 11.

Then, in a manner similar to that for the first lens face 4, the coordinates of the center point of each second lens face 6 are calculated, thereby performing the position measurement of the second lens face 6.

However, for the calculation of the position reference point, or in other words, the point of origin (0,0) in this instance, instead of the above-described image of the first inner peripheral surface end section of the positioning hole 7, an image of an opposing end section on the second lens face 6 side of the inner peripheral surface of the positioning hole 7 (referred to, hereinafter, as a second inner peripheral surface end section) is used. This is because the image of the first inner peripheral surface end section of the positioning hole 7 cannot be detected from the second lens face 6 side due to the thickness of the light-transmissive substrate 2.

When the position accuracy of the first lens face 4 and the second lens face 6, of which the position measurement has been performed as described above, is evaluated, whether or not the position accuracy of the first lens face 4 and the second lens face 6 is favorable is judged based on whether or not the coordinates of the center point of each first lens face 4 and second lens face 6 are within a predetermined allowable error (such as φ0.1) from the designed coordinates, and whether or not the relative misalignment between the coordinates of the respective center points of the first lens face 4 and the second lens face 6 corresponding with each other is within a predetermined allowable value (such as φ0.1).

Patent Literature 1: Japanese Patent Laid-open Publication No. 2009-229996

### DISCLOSURE OF INVENTION

### Problem to be Solved by the Invention

However, conventionally, when the position measurement of one lens face 4 is completed and the process switches to the position measurement of the other lens face 6, the lens array 1 is required to be reversed and reset in the measuring device 8. In addition, a position reference point differing from the position reference point used in the position measurement of the one lens face 4 is required to be newly reset. Therefore, a problem occurs in that the position measurement of both lens faces 4 and 6 requires significant effort, time, and cost.

Furthermore, the position reference points respectively determined for the position measurements of the lens faces 4 and 6 become misaligned in some instances because of error in the shapes of the positioning holes 7, error in setting when the lens array 1 is reset in the measuring device 8, and the like. In such instances, when the coaxial accuracy between corresponding lens faces 4 and 6 is evaluated, the coordinates of the center points of the lens faces 4 and 5 are calculated with reference to the points of origin that are misaligned with each other. Therefore, a problem also occurs in that accurate judgment becomes difficult.

These issues are very significant in the lens array 1 that has a plurality of lens faces 4 and 6, and have become even more serious as multi-channelling advances in recent lens arrays 1.

Therefore, the present invention has been achieved in light of the above-described issues. An object of the present invention is to provide a lens array and a lens edge detection method for the lens array capable of reducing the effort, time, and cost required for position measurement of lens faces, and improving measurement accuracy and mass-productivity.

### Means for Solving Problem

To solve the above-described issues, a lens array according to a first aspect of the present invention is a lens array including: a plurality of circular first lens faces formed on one end surface in a thickness direction of a plate-shaped light-transmissive substrate; and a plurality of circular second lens faces formed on the other end surface in the thickness direction of the light-transmissive substrate such as to be respectively coaxial with the plurality of first lens faces and respectively corresponding to the first lens faces. To enable detection of images of peripheral end sections of the first lens face and the second lens face, when positions of the first lens faces and the second lens faces are measured, to be performed simply by detection operations from the first lens face side, the first lens face is formed having a smaller diameter than the second lens face corresponding to the first lens face, and the image of the peripheral end section of the second lens face can be detected from the first lens face side by transmission of light by the light-transmissive substrate.

In the invention according to the first aspect, the first lens face is formed having a smaller diameter than the second lens face, and the image of the peripheral end section of the second lens face can be detected from the first lens face side by the transmission of light by the light-transmissive substrate. Therefore, the detection of the images of the peripheral end sections of the first lens face and the second lens face when the positions of the first lens face and the second lens face are measured can be performed in a single-procedure manner simply by detection operations from the first lens face side. As a result, the lens array is not required to be reversed when the position measurement of the second lens face is performed after the position measurement of the first lens face. In addition, the position measurement of the first lens face and the second lens face can be performed with high accuracy using a single position reference.

In addition, a lens array according to a second aspect is the lens array according to the first aspect, in which a certain shape capable of being used for setting a position reference when the position of the first lens face is measured is formed in the light-transmissive substrate such as to be detectable from the first lens face side.

In the invention according to the second aspect, the position reference based on the certain shape set during the position measurement of the first lens face can be used as is for the position measurement of the second lens face.

Furthermore, a lens array according to a third aspect is the lens array according to the second aspect, in which the certain shape is an outer shape of a positioning structure used to perform positioning when an optical transmission body or a photovoltaic device to be attached to the one end surface is attached.

In the invention according to the third aspect, a shape that is already present can be used for the position measurement of the lens faces.

Still further, a lens array according to a fourth aspect is the lens array according to any one of the first to third aspects, in which the first lens face and the second lens face are formed such that divergent light entering either of the first lens face and the second lens face is emitted from the other of the first lens face and the second lens face as convergent light.

In the invention according to the fourth aspect, optical coupling between an optical transmission body and a photovoltaic device, and optical coupling between optical transmission bodies can both be appropriately performed.

A lens edge detection method according to a fifth aspect is a lens edge detection method for detecting images of peripheral end sections of a first lens face and a second lens face by a predetermined measuring device, the detection being performed on a lens array including a plurality of circular first lens faces formed on one end surface in a thickness direction of a plate-shaped light-transmissive substrate and a plurality of circular second lens faces formed on the other end surface in the thickness direction of the light-transmissive substrate such as to be respectively coaxial with the plurality of first lens faces and respectively corresponding to the first lens faces, when measurement of the positions of the first lens face and the second lens face is performed using the measuring device. The lens edge detection method includes: a first step of forming the lens array such that the first lens face has a smaller diameter than the second lens face; a second step of setting the lens array formed at the first step on a predetermined setting position in the measuring device such that the first lens faces face an image-forming optical system of the measuring device; a third step of focusing the image-forming optical system on a peripheral end section of the first lens face in the lens array set on the setting position at the second step and detecting an image of the peripheral end section of the first lens face; and a fourth step of focusing the image-forming optical system on a peripheral end section of the second lens face in the lens array set on the setting position at the second step and detecting an image of the peripheral end section of the second lens by transmission of light by the light-transmissive substrate.

In the invention according to the fifth aspect, the detection of the images of the peripheral end sections of the first lens face and the second lens face when the positions of the first lens face and the second lens face are measured can be performed simply by detection operations from the first lens face side, as a result of the first to fourth steps. Therefore, the lens array is not required to be reversed when the position measurement of the second lens face is performed after the position measurement of the first lens face. In addition, the position measurement of the first lens face and the second lens face can be performed with high accuracy using a single position reference.

### Effect of the Invention

In the present invention, the effort, time, and cost required for position measurement of lens faces can be reduced, and measurement accuracy and mass-productivity can be improved.

### BRIEF DESCRIPTION OF DRAWINGS

FIG. 1 shows a cross-sectional view and a partial enlarged view of a lens array according to an embodiment of the present invention.

FIG. 2 shows a planar view of the lens array in FIG. 1.

FIG. 3 shows a bottom view of the lens array in FIG. 1.

FIG. 4 shows a planar view of a variation example of the lens array of the present invention.

FIG. 5 shows a bottom view of FIG. 4.

FIG. 6 shows a conceptual diagram of a lens edge detection method according to the embodiment of the present invention.

FIG. 7 shows a cross-sectional view of an example of a conventional lens array.

FIG. 8 shows a planar view of FIG. 7.

FIG. 9 shows a bottom view of FIG. 7.

FIG. 10A and FIG. 10B show conceptual diagrams of a position measurement method for lens faces in the conventional lens array.

FIG. 11 shows a schematic view of an example of a method of setting a reference point in the position measurement method in FIG. 10A and FIG. 10B.

### EXPLANATIONS OF LETTERS OR NUMERALS

2 light-transmissive substrate
3 upper end surface
4 first lens face
5 lower end surface
6 second lens face
20 lens array

### BEST MODE(S) FOR CARRYING OUT THE INVENTION

(Lens Array According to an Embodiment)

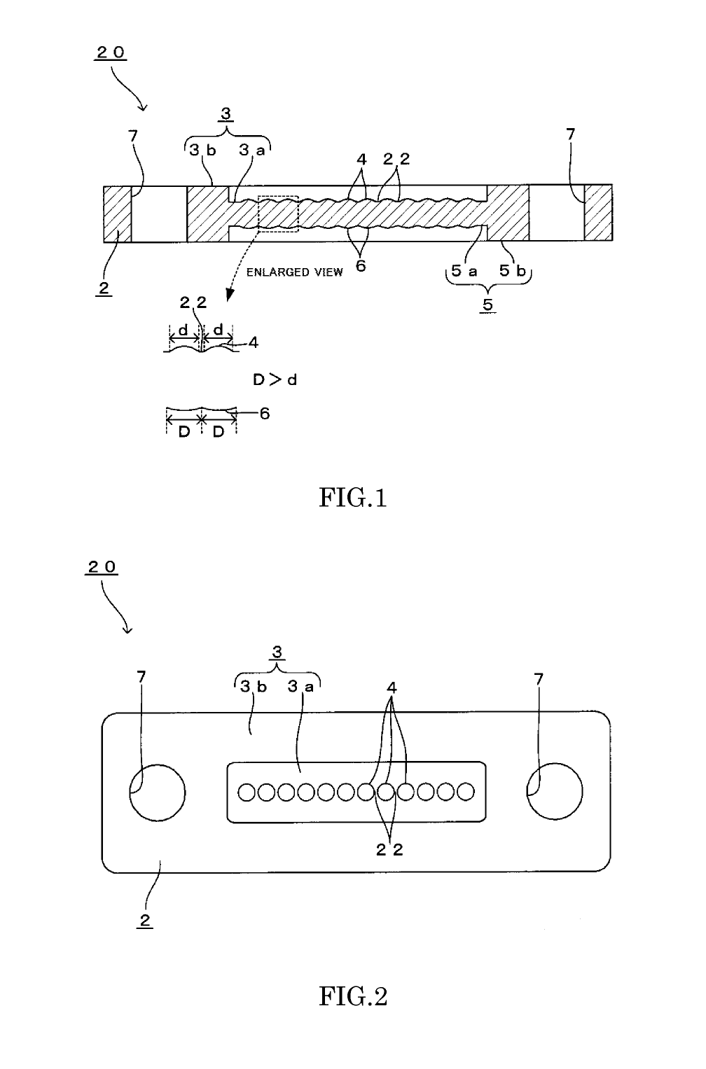

A lens array according to an embodiment of the present invention will hereinafter be described, focusing on the differences from a conventional lens array, with reference to FIG. 1 to FIG. 5.

Sections of which the basic configuration is the same or similar to that of the conventional lens array will be described using the same reference numbers.

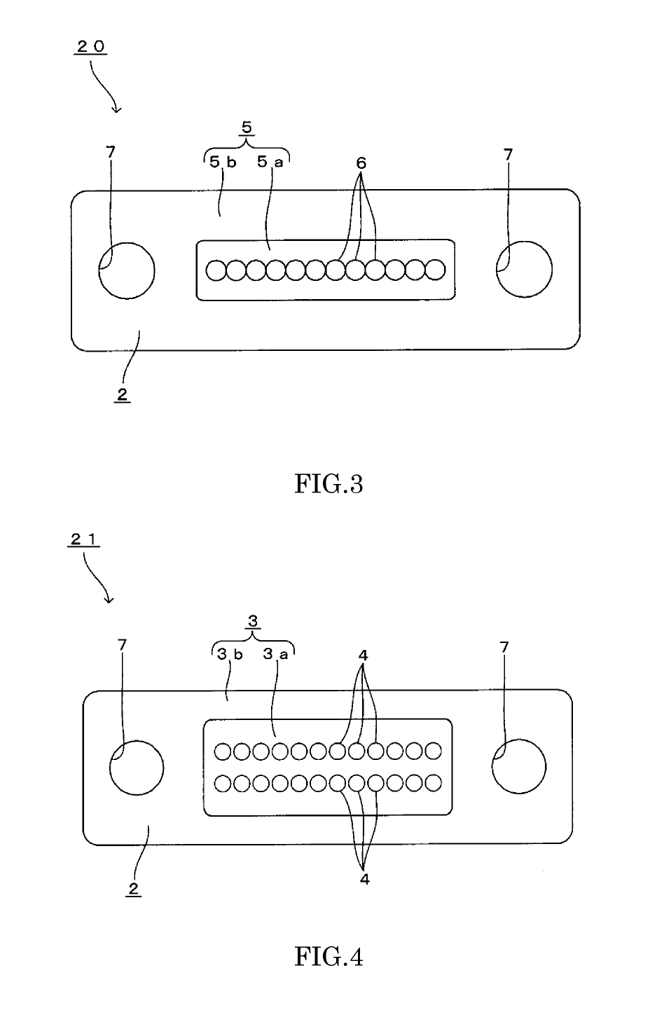

FIG. 1 is a cross-sectional view and a partial enlarged view of a lens array 20 according to the present embodiment. FIG. 2 is a planar view of FIG. 1. FIG. 3 is a bottom view of FIG. 1.

Unlike the conventional lens array 1, the lens array 20 according to the present embodiment is formed such that the detection of the images of the peripheral end sections of the first lens face 4 and the second lens face 6 during position measurement of the first lens face 4 and the second lens face 6 can be performed simply by detection operations from the first lens face 4 side.

In other words, as shown in FIG. 1, the lens array 20 according to the present embodiment is formed such that a diameter d of the first lens face 4 is smaller than a diameter D of the second lens face 6 corresponding with the first lens face 4. This relationship is established for all first lens faces 4. As a result, the image of the peripheral end section of the second lens face 6 can be detected from the first lens face 4 side by transmission of light by the light-transmissive substrate 2. The value of D may be 250 μm and the value of d may be 230 μm.

As a result of this configuration, as long as the position reference point (or in other words, the point of origin) for the position measurement of the first lens face 4 is determined, the reference point can be used as is for the position measurement of the second lens face 6 that can be detected (captured) from the first lens face 4 side by the transmission of light by the light-transmissive substrate 2. In a manner similar to the conventional lens array 1, the outer shape (certain shape) of the positioning hole 7 (positioning structure) may be used to set the reference point. However, because only the reference point on the first lens face 4 side is required to be set according to the present embodiment, only the image of the first inner peripheral surface end section of the positioning hole 7 is required to be detected, and the image of the second inner peripheral surface end section of the positioning hole 7 is not required.

Therefore, unlike in the conventional lens array 1, the effort of reversing the lens array 1 when the process switches to the position measurement of the second lens face 6 after the position measurement of the first lens face 4, and the operation for separately calculating a new reference point for the position measurement of the second lens face 6 that differs from the reference point for the position measurement of the first lens face 4 are not required.

Furthermore, because the position measurement of both the first lens face 4 and the second lens face 6 can be performed using a single reference point, evaluation of the coaxial accuracy of the first lens face 4 and the second lens face 6 can be appropriately performed.

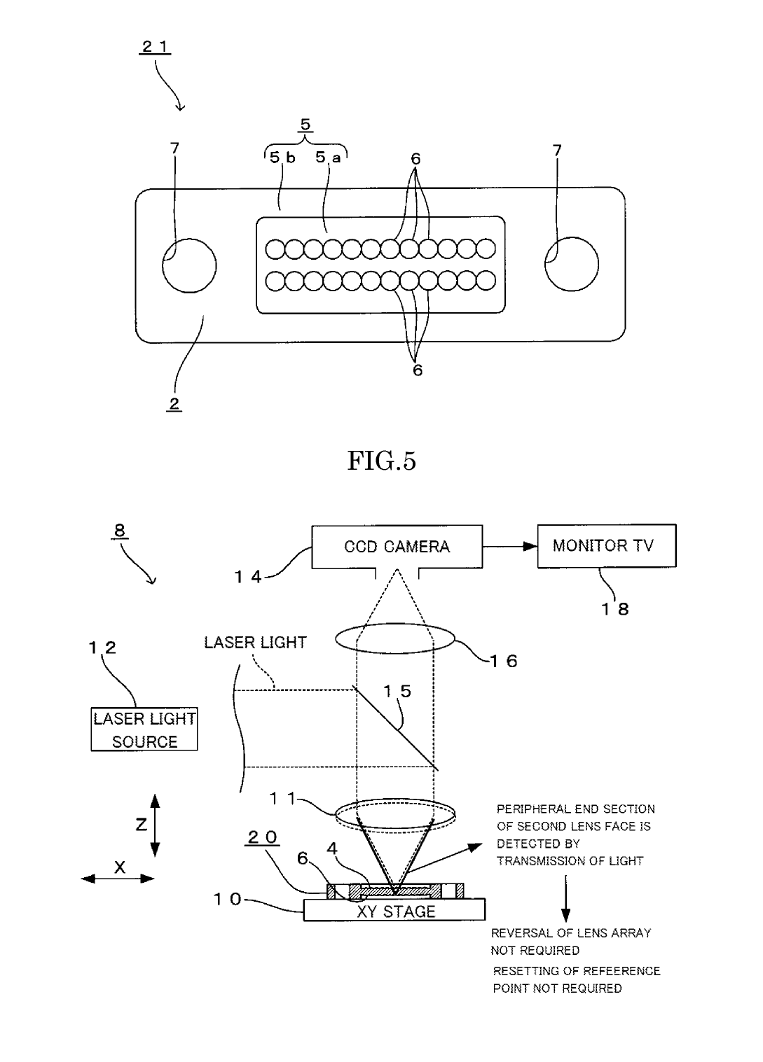

The present invention can be effectively applied not only to the 12-channel lens array 20 shown in FIG. 1 to FIG. 3, but also, for example, to a 24-channel lens array 21 shown in FIG. 4 and FIG. 5. The lens array 21 shown in FIG. 4 and FIG. 5 is configured such that two rows of the succession of 12 first lens faces 4 are disposed in parallel, and two rows of the succession of 12 second lens faces 6 are disposed in parallel.

The lens faces 4 and 6 may be formed such that the divergent light entering either of the lens faces 4 and 6 is emitted from the other lens face 4 or 6 as convergent light.

Furthermore, the radius of curvature of the lens face 4 and that of the lens face 6 may be the same or may differ.

Still further, to appropriately detect the image of the peripheral end section of the second lens face 6 by the detection operations from the first lens face 4 side, the object beam from the peripheral end section of the second lens face 6 is preferably transmitted through the light-transmissive substrate 2 towards the first lens face 4 side and emitted from an emission position on the first lens face 4 side in the same direction as the optical axis direction of the first lens face 4. To secure an emission position such as this for the object beam from the peripheral end section of the second lens face 6, a gap portion between adjacent first lens faces 4 is preferably formed into a flat surface 22 that is perpendicular to the optical axis direction.

(Lens Edge Detection Method According to the Embodiment)

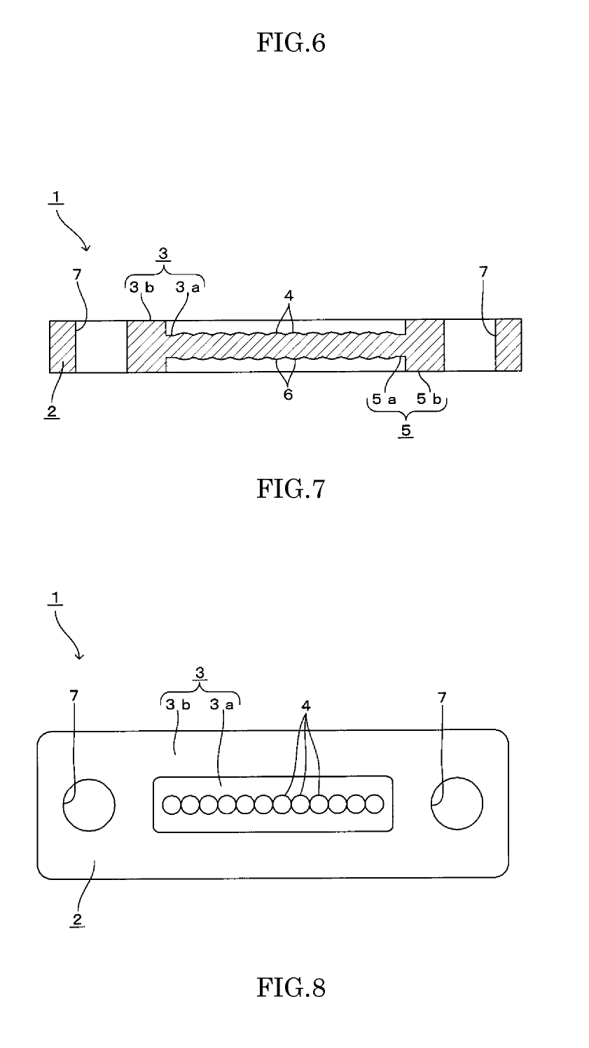

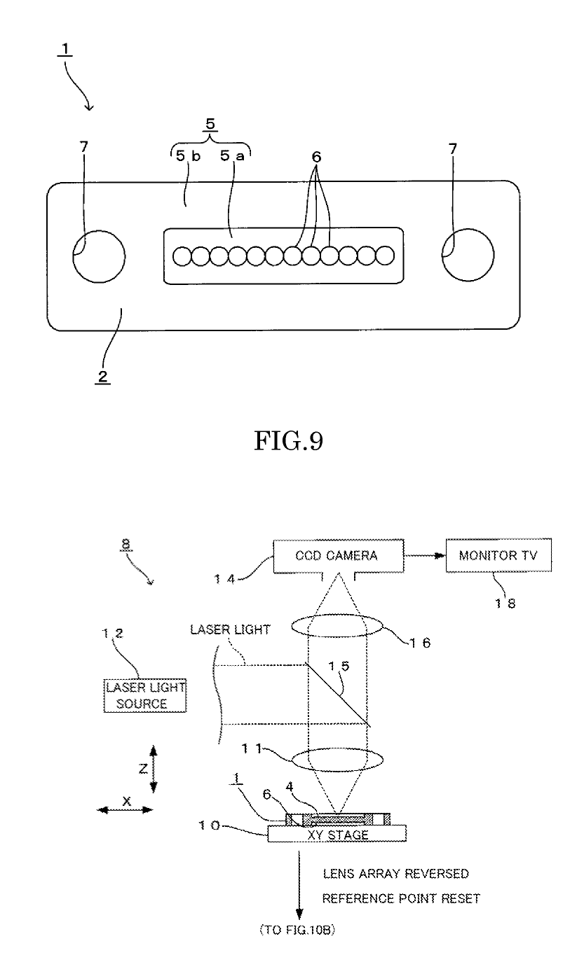

Next, a lens edge detection method according to the embodiment of the present invention will be described with reference to FIG. 6.

According to the present embodiment, first, the above-described lens array 20 (21) is formed (first step).

The subsequent procedures (steps) according to the present embodiment are performed as single procedure in the position measurement of the first lens face 4 and the second lens face 6.

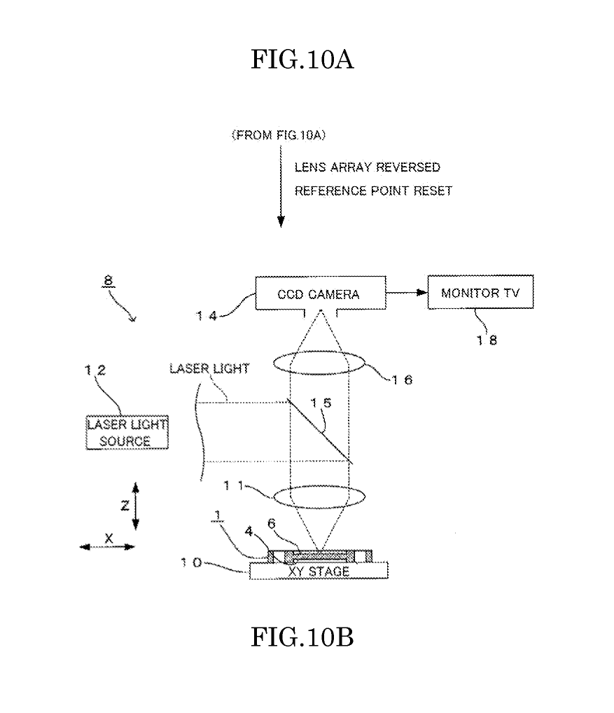

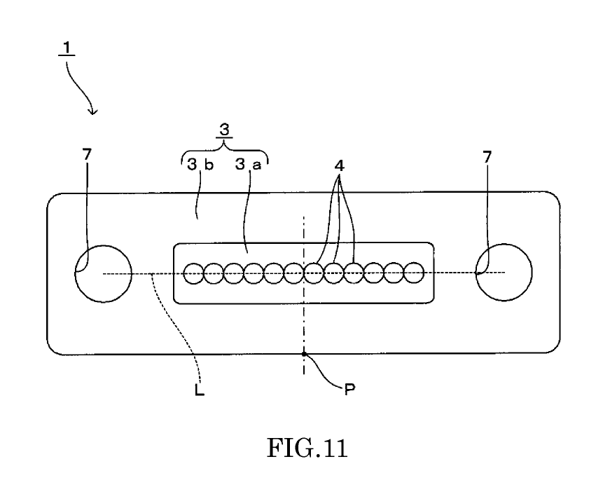

In other words, after the first step, in a manner similar to that shown in FIG. 10A, the lens array 20 (21) is set on the XY stage 10 such that the first lens faces 4 face the objective lens 11 serving as a image-forming optical system of the measuring device 8 (second step).

Then, in a manner similar to that of the conventional method, a reference point based on the detected images of the first inner peripheral surface end sections of the positioning holes 7 is set.

Next, the objective lens 11 is focused on the peripheral end section of the first lens face 4 of the lens array 20 (21) and an image of the peripheral end section of the first lens face 4 is detected (third step). In a manner similar to the conventional method, the detection of the image of the peripheral end section of the first lens face 4 at the third step is performed as a series of detection operations for detecting a plurality of points on the peripheral end section.

Next, in a manner similar to that of the conventional method, the coordinates of the center point of the first lens face 4 is calculated based on the image of the peripheral end section of the first lens face 4 detected at the third step.

Then, in a manner similar to that of the conventional method, the calculation for the coordinates of the center point of the first lens face 4 is performed on all first lens faces 4, and the position measurement of the first lens face 4 is thereby completed.

Next, the process transitions to the position measurement of the second lens face 6. At this time, the lens array 20 (21) is not required to be reversed and reset on the XY stage 10, nor is a new position reference point required to be set.

In other words, according to the present embodiment, after the position measurement of the second lens face 6 is started, first, the objective lens 11 is focused on the peripheral end section of the second lens face 6 of the lens array 20 (21) set on the XY stage 10 by the transmission of light by the light-transmissive substrate 2, and the detection of the image of the peripheral end section of the second lens face 6 is performed (fourth step). The detection of the image of the peripheral end section of the second lens face 6 at the fourth step is performed as a series of detection operations for detecting a plurality of points on the peripheral end section.

Next, in a manner similar to that for the first lens face 4, the coordinates of the center point of the second lens face 6 is calculated based on the image of the peripheral end section of the second lens face 6 detected at the fourth step.

Then, the calculation for the coordinates of the center point of the second lens face 6 is performed on all second lens faces 6, and the position measurement of the second lens face 6 is thereby completed.

As described above, according to the present embodiment, the first lens face 4 is formed having a smaller diameter than the second lens face 6, and the image of the peripheral end section of the second lens face 6 can be detected from the first lens face 4 side by the transmission of light by the light-transmissive substrate 2. Therefore, the detection of the images of the peripheral end sections of the first lens face 4 and the second lens face 6 during position measurement of the first lens face 4 and the second lens face 6 can be performed simply by the detection operations from the first lens face 4 side. As a result, the effort of reversing the lens array 20 (21) is no longer required for the position measurement of the second lens face 6 after the position measurement of the first lens face 4, and the position measurement of the first lens face 4 and the second lens face 6 can be performed with high accuracy using a single position reference point. Therefore, the effort, time, and cost required for the position measurement of the first lens face 4 and the second lens face 6 can be reduced. In addition, measurement accuracy and mass-productivity can be improved.

The present invention is not limited to the above-described embodiment. Various modifications can be made without compromising the features of the present invention.

For example, the present invention can be effectively applied to a lens array having more than 24 channels.

In addition, the present invention can be effectively applied to an optical transmission body other than optical fibers, such as an optical waveguide.

Furthermore, in the present invention, as long as the process of determining the position reference point by imaging from the first lens face 4 side is adhered to, either of the position measurement of the first lens face 4 and the position measurement of the second lens face 6 may subsequently be performed first.

Still further, when the positioning of the optical transmission body and the photovoltaic device is performed by optical reading of an alignment mark formed on the lens array, the outer shape of the alignment mark maybe used as the certain shape and used to set the reference point for position measurement.

1. A lens array comprising:
a plurality of circular first lens faces formed on one end surface in a thickness direction of a plate-shaped light-transmissive substrate; and
a plurality of circular second lens faces formed on the other end surface in the thickness direction of the light-transmissive substrate such as to be respectively coaxial with the plurality of first lens faces and respectively corresponding to the first lens faces, wherein
to enable detection of images of peripheral end sections of the first lens face and the second lens face, when positions of the first lens faces and the second lens faces are measured, to be performed simply by detection operations from the first lens face side, the first lens face is formed having a smaller diameter than the second lens face corresponding to the first lens face, and the image of the peripheral end section of the second lens face can be detected from the first lens face side by transmission of light by the light-transmissive substrate.

2. The lens array according to claim 1, wherein:
a certain shape capable of being used for setting a position reference when the position of the first lens face is measured is formed in the light-transmissive substrate such as to be detectable from the first lens face side.

3. The lens array according to claim 2, wherein:
the certain shape is an outer shape of a positioning structure used to perform positioning when an optical transmission body or a photovoltaic device to be attached to the one end surface is attached.

4. The lens array according to claim 1, wherein:
the first lens face and the second lens face are formed such that divergent light entering either of the first lens face and the second lens face is emitted from the other of the first lens face and the second lens face as convergent light.

5. A lens edge detection method for detecting images of peripheral end sections of a first lens face and a second lens face by a predetermined measuring device, the detection being performed on a lens array including a plurality of circular first lens faces formed on one end surface in a thickness direction of a plate-shaped light-transmissive substrate and a plurality of circular second lens faces formed on the other end surface in the thickness direction of the light-transmissive substrate such as to be respectively coaxial with the plurality of first lens faces and respectively corresponding to the first lens faces, when measurement of the positions of the first lens face and the second lens face is performed using the measuring device, the lens edge detection method comprising:
a first step of forming the lens array such that the first lens face has a smaller diameter than the second lens face;
a second step of setting the lens array formed at the first step on a predetermined setting position in the measuring device such that the first lens faces face an image-forming optical system of the measuring device;
a third step of focusing the image-forming optical system on a peripheral end section of the first lens face in the lens array set on the setting position at the second step and detecting an image of the peripheral end section of the first lens face; and
a fourth step of focusing the image-forming optical system on a peripheral end section of the second lens face in the lens array set on the setting position at the second step and detecting an image of the peripheral end section of the second lens by transmission of light by the light-transmissive substrate.

6. The lens array according to any one of claim 2, wherein:
the first lens face and the second lens face are formed such that divergent light entering either of the first lens face and the second lens face is emitted from the other of the first lens face and the second lens face as convergent light.

7. The lens array according to any one of claim 3, wherein:
the first lens face and the second lens face are formed such that divergent light entering either of the first lens face and the second lens face is emitted from the other of the first lens face and the second lens face as convergent light.
